(19) United States
(12) Patent Application Publication
(10) Pub. No.: US 2001/0002386 A1
(43) Pub. Date: May 31, 2001

(54) Absorbent and process for making same

(75) Inventors: Richard Binion Steele, Arden, NC (US); Donald Frederick Evans, Raleigh, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: ABSORBENT AND PROCESS FOR MAKING SAME

(21) Appl. No.: 09/754,930

(22) Filed: Jan. 4, 2001

Related U.S. Application Data
(63) Continuation of application No. 09/261,512, filed on Mar. 3, 1999.
Application No. 09/261,512 is a continuation of application No. 08/771,476, filed on Dec. 24, 1996, now abandoned.

(51) Int. Cl. C09C 1/02

(52) U.S. Cl. 502/401; 423/555; 106/461; 106/632

(57) ABSTRACT

There is provided a granular absorbent based on calcium sulfate that may be used for absorbing oil and water-based liquids. The absorbent includes calcium sulfate obtained from gypsum, waste gypsum from wallboard, waste gypsum separated from wallboard, synthetic gypsum and mixtures thereof. The granular absorbent is ground and screened to a particle size between 4 mesh and about 100 mesh. In another aspect of the invention, an effective amount of a binder such as a clay, lignin or starch is added to the calcium sulfate to assist the calcium sulfate to pelletize and form granules. The granules are sized and dried. The granular absorbents are effective in absorbing oil or water and are easily disposed of. There is also disclosed processes for making the granular absorbents.

### BACKGROUND OF THE INVENTION

The present invention relates to a granular absorbent and to a process for making the absorbent. More particularly, the present invention relates to a granular absorbent based on calcium sulfate that may be used for absorbing oil and water-based liquids.

A variety of materials are used for the absorption of oil, grease, water and the like in both industry and households. Among the materials used for such purpose are wood chips, sawdust or sand but most spill absorbents currently in commerce are manufactured from ground clay. These products are not water-soluble, are frequently dusty, and thus are difficult to dispose of properly.

A material useful as an oil and water absorbent is described in U.S. Pat. No. 4,459,368 to Jaffe et al., which discloses a mixture of fuller's earth, preferably in the form of calcium bentonite, mixed with calcium sulfate dihydrate at a weight ratio of 1:9 to about 3:7. In addition, the particle size of the clay and the calcium sulfate dihydrate are such that no more than about 60 weight of clay and about 20 weight % of calcium sulfate particle are retained on a 6 mesh sieve screen. The manner of mixing is not important as the clay and calcium sulfate dihydrate are simply mixed to form the absorbent. Jaffe et al. state that the ratio of the weight of clay particles to the weight of calcium sulfate is important in order to maximize the liquid absorbing effect.

There continues to be a need for liquid spill absorbents for oil and water-based spills of a wide range of origins which have a high degree of absorption, can be made from waste materials, and are easily disposable.

### SUMMARY OF THE INVENTION

It is an object of the present invention to provide a granular absorbent that absorbs large amounts of oil or water, is substantially dust free, is environmentally safe, and is derived from by-product or waste materials.

Another object of the present invention is to provide a process for making a granular absorbent that absorbs large amounts of oil or water, is substantially dust free, is environmentally safe, and is derived from by-product or waste materials.

In accordance with the present invention there is provided an absorbent for oil and water-based liquid spills which is made by forming calcium sulfate into a granule of the desired size. The calcium sulfate materials which are used to make the absorbent of the present invention include gypsum, waste gypsum separated from wallboard, synthetic gypsum, and combinations of these materials. In one embodiment of this invention, the gypsum core from waste gypsum wallboard is separated from the paper in the board by crushing to pulverize the gypsum core and screening to separate the granular absorbent of the desired size from the paper and the undersized, dusty powder. The granular absorbent is screened or classified to a particle size between about 4 mesh and about 100 mesh, U.S. sieve series, and dried. The most typical particle size is between 8 mesh and 50 mesh. The undersized, dusty calcium sulfate powder may be agglomerated by passing it through an extruder in order to agglomerate the powder to a granule having the desired size and properties.

In another embodiment of the absorbent of the present invention it has been found that an oil or water absorbent having the desired properties may be made by adding to calcium sulfate powder an effective amount of a binder in order to agglomerate into a granule and then drying. Preferred binders include certain clays, especially bentonite clay, lignins and starches. The effective amount of binder will depend upon the binder selected. For example, when bentonite clay is the binding agent it may be present in an amount up to about 5.0%. Other binders will generally range in amounts from about 0.25% to about 10.0% by weight of the total composition, preferably from about 0.5% to about 2.0% by weight.

Another aspect of the present invention is to provide a process for producing a granular absorbent for absorbing both oil and water-based liquid spills. In one of the processes of this invention calcium sulfate is crushed and screened to separate the granular absorbent of the desired size from the paper and the undersized, dusty powder. The granular absorbent is screened or classified to a particle size between about 4 mesh and about 100 mesh, U.S. sieve series, and dried. In another process of this invention a granular absorbent is made from the undersized, dusty powder. A paste of powdered calcium sulfate is prepared and the paste is compacted by passing the paste through an extrusion mill at a pressure up to 1000 p.s.i., typically from about 300 p.s.i. to about 500 p.s.i., to form noodles which are broken into granules. The compacted granules are screened to the desired size to remove fines and oversized particles and then heated to fully dry. Absorbents made according to this process do not require a binder because the compaction of the extrusion and the heating provides a hard product. However, when it is desirable to add a binder, such as when lower temperatures are used, the binder may be added when the paste is formed.

Alternatively, it has been found that the granular absorbents may be made by crushing calcium sulfate, waste gypsum, or synthetic gypsum to a powder, and optionally, screening to remove any paper backing. The powdered calcium sulfate is mixed with a dry binder prior to introduction onto a pelletizer or the binder is added by misting an aqueous solution containing the binder onto the powdered calcium sulfate in a pelletizer, pelletizing to form granules, screening to a predetermined size, and drying the granules. Using this process the calcium sulfate absorbent is not compressed.

The granular absorbents of this invention are effective in absorbing oil or water-based liquid spills and are easily disposed of. When the absorbed material is water, the water-soluble properties of the absorbents of this invention allow the absorbent to be disposed of with no adverse consequences to the environment. The oil absorbent granules are designed to offer an alternative to traditional ground clay oil absorbents which are non-soluble. The reclaimed gypsum granules have been developed to respond to a growing need to significantly reduce the waste stream by manufacture of innovative products from residual value waste into useful, competitive applications.

Other objects, features and advantages of the present invention will be apparent from the following detailed description of the invention.

### DETAILED DESCRIPTION OF THE INVENTION

The present invention now will be described more fully hereinafter. This invention may, however, be embodied in many different forms and should not be construed as limited to the embodiments set forth herein; rather, these embodiments are provided so that this disclosure will be thorough and complete, and will fully convey the scope of the invention to those skilled in the art.

The absorbents of the present invention absorb large amounts of liquid due to their dry, porous character. In its broadest aspect, the absorbents of this invention are made from calcium sulfate. The calcium sulfate materials which are used to make the granular absorbents of the present invention include gypsum, waste gypsum, such as wallboard scrap, synthetic gypsum and combinations thereof. It is preferable to use waste gypsum wallboard because of its cost and availability. When using waste gypsum, the gypsum may be separated from wallboard, i.e., the paper having been removed, or the whole wallboard may be used, e.g., the gypsum and paper being ground together and both being incorporated into the absorbent. The drywall sheetrock or wallboard scrap is collected at construction sites and hauled to a process yard where this scrap is crushed and screened to separate the paper from the gypsum. The synthetic gypsum may, for example, be waste or by-product gypsum from various industrial processes such as flue gas desulphurization.

It has been found that liquid spill granular absorbents may be made by separating the gypsum core from wallboard and screening into a granular material of the desired size. One method of making the granular absorbent involves separating the gypsum core from the paper in the board. This process includes a crushing step to pulverize the gypsum core and a separation step to remove the paper and classifying to obtain a granular gypsum absorbent product that is typically between about 4 mesh down to some fine sized particle which is not dust and the product is dried. The granular absorbent is screened to a particle size between about 4 mesh and about 100 mesh, U.S. sieve series. The size of the granules desired will be determined by the intended end use, e.g., as an oil absorbent or a water absorbent, with the size being between 4 mesh and 100 mesh, preferably between 8 mesh and 50 mesh. The screening leaves as by-products paper and gypsum dust.

An alternative product of this invention is made by converting the by-product dust and paper into a granular absorbent material that could be intermixed with the granulated core derived product or marketed separately. This can be done by running the paper through a shredding or “fiberizing” mill in order to break it down onto a relatively fine fiber that looks like fluff. The fluff can then be mixed with the gypsum dust and agglomerated by various methods into a granule that has absorbent qualities. The agglomeration processes includes extrusion pelletization (via auger extrusion or roller type pellet mill) with a subsequent process for converting the pellets into a granular material (e.g., shredding, cutting, etc.) or followed by a granule polishing or dressing step which involves the use of some type of rotary balling or rounding device such as a pan or drum agglomerator. An absorbent having the desired properties may be formed at extrusion pressures up to about 1000 p.s.i., preferably a pressure between 300 p.s.i. and 500 p.s.i.

When the granular absorbent is made from whole wallboard no separation of paper and gypsum is needed. Instead, the whole board is ground up in such a way that the paper component of the board is converted to fluff similar to the above-described method. This whole material mixture is then agglomerated via the same methods described above. Drying and sizing is also required. When the granular absorbent is made from synthetic gypsum the agglomeration process options are identical to those described herein. Simply drying the material to the point where the surface moisture is removed is sufficient. This applies to all the agglomeration/granulation scenarios for producing liquid spill absorbents. Synthetic gypsum materials can be incorporated into any of these mixes that are destined for agglomeration.

In another embodiment of the absorbent, a binder is added to the calcium sulfate to assist in granular formation. It has been found that effective binders may include, for example, clays, lignins, starches, gums, cellulosic ethers, and water-soluble polymers. Although the amount of binder will vary depending upon the binder it is preferable to use an amount of binder necessary to promote the desired granular formation.

When a clay is the binder, typical clays include montmorillonite, kaolin, illite, halloysite, vermiculite, attapulgite, seppiolite, smectite, fuller's earth and the like. The bentonite clays are preferred for their absorbing and binding properties, especially the sodium and calcium bentonites (clays largely composed of montmorillonite but which can also contain beidellite, attapulgite, and similar minerals). When the clay binder is bentonite clay, it may be mixed with the calcium sulfate in amounts up to about 5.0% by weight, preferably from about 0.5% by weight to about 2.0% by weight. Other clay binders may be used in amounts up to about 10.0% by weight.

Another suitable class of binder is lignin. Lignin is a polymeric substance composed of substituted aromatics primarily obtained as a by-product of the pulp and paper industry from the residual pulping liquors. Lignin obtained by any pulping method or from any source may be used in the process of this invention as long as the lignin is in a form which becomes soluble in water, such as lignosulfates and sulfonated lignin. Among the lignins which may be used as binders are calcium lignosulfonate, sulfonated lignin, such as sodium sulfonated lignin, POLYFON F® and sulfonated alkali lignin, REAX® 80C. These lignin are available from Westvaco Corporation, North Charleston, S. C. When a lignin is the binder, it may be used in amounts up to about 5.0% by weight (solids), preferably from about 1.5% to about 3.0% by weight (solids).

Other binders include water-soluble cellulosic ethers, such as carboxymethyl-cellulose. When cellulose ethers are used as the binder, they may be added to the calcium sulfate in an amount up to about 2.0% by weight, preferably in an amount up to about 1.0% by weight. In addition, starches, such as wheat paste; gums, such as xanthin gum, guar gum; alginates; and water-soluble polymers such as polyvinyl pyrrolidone and polyvinyl alcohol are useful water-soluble binders. These binders may be used in amounts up to 5.0% by weight. To include amounts of these binders above about 5.0% does not increase the absorbing properties of the granules to any appreciable extent.

For some absorbents dusting is a problem; therefore, a granule of +100 mesh is typically desirable. Given the difficulty of screening to 100 mesh at high production rates, the absorbent may be preferably screened at about +50 mesh, U.S. Standard Screen Series (ASTM). Other separation techniques can be employed which can remove the dusty particles down in the range of 100 mesh and below, such as air separation. The importance of the upper particle size ranges is related to the ultimate absorption of the product. Large particle sizes or coarsely graded absorbents have less surface area per unit weight than small particles. Therefore it is desirable to have a consistent particle size distribution that lends itself to a maximum packing arrangement. Given the separation techniques, a maximum particle size of about 4 mesh is workable, but 6 or 8 mesh is usually better. Implicit in this secondary process is the need to size and dry the agglomerated materials.

Another aspect of the present invention is to provide a process for producing the calcium sulfate based granular absorbent for oil and water-based liquid spills.

In one embodiment of this invention, the gypsum core from waste gypsum is separated from the paper in the board by crushing to pulverize the gypsum core and screening to separate the granular absorbent of the desired size from the paper and the undersized, dusty powder. The granular absorbent is screened or classified to a particle size between about 4 mesh and about 100 mesh, U.S. sieve series, and dried. The most typical particle size is between 8 mesh and 50 mesh. The undersized, dusty calcium sulfate powder may be agglomerated by passing it through an extruder in order to agglomerate the powder to a granule having the desired properties.

In one preferred process, gypsum, waste gypsum, synthetic gypsum or a combination thereof is processed to a powder form and the gypsum powder is conveyed to a mixing station where a paste is formed with water. The paste will generally have from 10% by weight to about 30% by weight water. The calcium sulfate paste is compacted by extruding the paste through the die of, for example, a pug mill, to create a compacted form, usually a noodle, under either ambient or de-airing conditions. The materials are compacted at a pressure up to 1000 p.s.i., preferably between about 300 and 500 p.s.i. Pressures of this magnitude will tightly compress the calcium sulfate making a very high quality product. One aspect of a granular absorbent's quality is its durability or its tendency to resist degradation into dust. Another is its porosity. A porous granule is desirable.

The noodles obtained directly from the extruder die are generally not useful sizes or shapes for absorbents which should be a granular material with a well distributed particle size. Therefore, the noodles are broken down into pellets which are screened to remove fines and oversized particles which can then be recycled. Size reduction can be accomplished by a variety of methods and at different stages of the process after extrusion. The most direct method of size reduction is to shred the noodles with a rotating blade right at the die. The fineness of the granules and the particle size distribution depends upon the size of the die opening, the speed of the cutter, the number of blades on the cutter, and how closely the cutter blade is positioned to the exit surface of the die.

Size reduction can also be achieved with several type of separate grinding apparatus. A third option is two use both a die mounted fly cutter in conjunction with an auxiliary shredder. Depending upon the material mix and the size reduction method it may be desirable to have an intermediate drying step to bring the compacted noodles to an optimum moisture content for grinding in order to produce the best granular material with the least amount of rejects. Usually it is necessary and desirable to bring the material to moderately dry state where it ceases to deform plastically and will crush or break to make granules without producing dust. Optionally, a binder such as those described above may be added to the paste.

The pellets are then dried. The drying temperature will depend upon the type of drying equipment used, such as a rotary dryer or a fluid bed dryer.

In another embodiment of the agglomeration process is to form the mixture of paper fluff and dust directly into a granule via a rotary balling device such as a pan or drum agglomerator, a pin mixer, or perhaps a “Schugi Flexomix” vertical shaft agglomerator where a binder is dry mixed with the gypsum or the binder is misted onto the gypsum powder as it is introduced a pelletizer, such as a rotating disc pelletizer, pin mixer, rotary drum or the like, to form granules. The granules are discharged from the pelletizer onto a conveyor belt which introduces the pellets to a sizing screen and/or a dryer, such as a rotary dryer. These agglomeration processes all require the addition of at least water to the mixture in order to effect the agglomeration.

The characteristics of the calcium sulfate based absorbents of this invention allows the oil-containing absorbent to be recycled with no adverse consequences to the environment.

### EXAMPLE 1

An absorbent according to the present invention was made by grinding waste gypsum wallboard in a roll crusher to a particle size between about 2 to 5 mm. The ground material was conveyed to a screen where almost all of the wallpaper paper covering was separated from the powdered gypsum. The gypsum was conveyed to a tank where it was mixed with water to a moisture content of approximately 15% to form a paste. The paste was then agglomerated by passing through an extruder to compact the calcium sulfate. The noodles were then crushed and screened to form a granule having a particle size of from 6 mesh to 30 mesh. The granules were then dried. The resulting absorbent was dry, granule having good absorption properties for oil and water-based liquid spills.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed is:

1. A granular absorbent for oil and water-based liquid spills comprising calcium sulfate, said calcium sulfate having a particle size between 4 mesh and about 100 mesh.

2. The granular absorbent according to claim 1 wherein said calcium sulfate is a member of the group consisting of gypsum, waste gypsum, synthetic gypsum and mixtures thereof.

3. The granular absorbent according to claim 1 wherein said calcium sulfate having been compacted at a pressure between about 300 p.s.i. and 500 p.s.i.

4. The granular absorbent according to claim 1 wherein said calcium sulfate has a particle size between 8 mesh and 50 mesh.

5. A granular absorbent for oil and water-based liquid spills comprising dry gypsum obtained by crushing gypsum wallboard to a particle size between 8 mesh and 50 mesh.

6. A granular absorbent for oil and water-based liquid spills comprising calcium sulfate absorbent and an effective amount of a binder to cause said calcium sulfate to pelletize, said calcium sulfate and said binder being pelletized and then screened to a particle size range between 4 mesh and 100 mesh.

7. The granular absorbent according to claim 6 wherein said calcium sulfate is a member of the group consisting of gypsum, waste gypsum, synthetic gypsum and mixtures thereof.

8. The granular absorbent according to claim 6 wherein said binder is a clay and is present in an amount from about 0.25% to about 10.0% by weight.

9. The granular absorbent according to claim 6 wherein said clay is a bentonite clay and is present in an amount from about 0.5% to about 2.0% by weight.

10. The granular absorbent according to claim 9 wherein said clay is sodium bentonite.

11. The granular absorbent according to claim 6 wherein said binder is a water-soluble lignin and is present in an amount up to about 5.0% by weight.

12. The granular absorbent according to claim 6 wherein said binder is a member of the group consisting of water-soluble cellulosic ethers, alginates, starches, gums, polyvinyl pyrrolidone, and polyvinyl alcohol.

13. The granular absorbent according to claim 12 wherein said binder is carboxymethylcellulose and is present in an amount up to about 1.0%.

14. The granular absorbent according to claim 6 wherein said binder is a member of the group consisting of wheat paste, xanthin gum and guar gum.

15. A granular absorbent comprising calcium sulfate and from about 0.4% to about 5.0% by weight of a water-soluble lignin, said calcium sulfate absorbent and said lignin being pelletized, and said pellets having a particle size between about 8 mesh and about 50 mesh.

16. A granular absorbent comprising calcium sulfate and from 0.5% to about 2.0% by total weight of sodium bentonite, said calcium sulfate absorbent and said sodium bentonite having been formed into pellets, said pellets a particle size between about 8 mesh and about 40 mesh.

17. A process for producing a granular absorbent for use in absorbing oil or water-based liquid spills composition comprising:
crushing and screening calcium sulfate to a powder;
forming a paste of said calcium sulfate;
compacting said paste by extrusion through an extrusion mill and forming granules;
screening said granules to a predetermined particle size; and
drying said granules.

18. The granular absorbent according to claim 17 wherein said calcium sulfate is a member of the group consisting of gypsum, waste gypsum, synthetic gypsum and mixtures thereof.

19. The process according to claim 17 further comprising mixing said powdered calcium sulfate with an effective amount of a binder aid in compaction.

20. The process according to claim 17 wherein said calcium sulfate is drywall scrap that has been ground and screened to separate paper therefrom.

21. The process according to claim 19 wherein said binder is a bentonite clay and is present in an amount from about 0.5% to about 2.0% by weight.

22. The process according to claim 19 wherein said binder is a water-soluble lignin and is present in an amount up to about 5.0% by weight.

23. The process for producing a granular absorbent for use in absorbing oil or water-based liquid spills comprising:
grinding a calcium sulfate selected from the group consisting of gypsum, waste gypsum, synthetic gypsum and mixtures thereof;
screening said ground calcium sulfate to a particle size between about 4 mesh and 100 mesh;
separating said sized particles from undersized and oversized material; and
drying said particles.
